(19) United States
(12) Patent Application Publication
(10) Pub. No.: US 2022/0101749 A1
(43) Pub. Date: Mar. 31, 2022

(54) METHODS AND SYSTEMS FOR FRICTIONLESS NEW DEVICE FEATURE ON-BOARDING

(71) Applicant: Sony Interactive Entertainment LLC, San Mateo, CA (US)

(72) Inventor: Jennifer Sheldon, San Mateo, CA (US)

(21) Appl. No.: 17/035,605

(22) Filed: Sep. 28, 2020

(51) Int. Cl. G09B 19/00; G09B 5/02

(52) U.S. Cl. CPC G09B 19/003; G06Q 30/016; G09B 5/02

(57) ABSTRACT

Methods, systems, and computer programs are provided for on-boarding users to new features of a device. One method includes detecting use of the device by the user during a session. The method includes detecting an interactive scenario during use of the device. The interactive scenario including a plurality of device features usable to move along interactive pathways for the interactive scenario. The method includes identifying the new device feature along a new interactive pathway during said use of the device. The identifying of the new device feature is based on learning of device features used by the user in one or more prior interactive scenarios. The method includes identifying a training scenario for the new device feature. The training scenario is accessible via an interactive interface that enables demonstration use of the new device feature. The new device feature is identified for said training scenario when the new device feature is present as an option along one or more of said interactive pathways.

### BACKGROUND

### 1. Field of the Disclosure

The present disclosure relates generally to the dynamic monitoring a user's interaction with a device, and more particularly to methods and systems for on-boarding users to new features of the device.

### 2. Description of the Related Art

The consumer electronics industry has seen many changes over the years. The consumer electronics industry has been trying to find ways to improve a user's on-boarding process for new devices by simplifying the process and making it more seamless. To this end, developers have been seeking ways to incorporate sophisticated operations that can assist a user with their on-boarding experience of a new device or product and to make the experience frictionless as possible.

A growing trend in the consumer electronics industry is to develop tools and features to help users with their on-boarding process when setting up and learning how to use their new device. Having a positive initial impression of the new device may result in greater consumer satisfaction and may lead to higher brand loyalty. Unfortunately, as devices become more sophisticated and complex, the on-boarding experience has become more difficult, particularly for users who traditionally struggle with adapting to new changes in technology. Consequently, users may spend a significant amount of time aimlessly exploring various features on their new device in order to learn features that may not even be relevant to the user's intended use or may not be interesting to the user. This may result in the user being frustrated with their new device or can result in dissatisfaction with the undue complexities of their new device.

It is in this context that implementations of the disclosure arise.

### SUMMARY

Implementations of the present disclosure include methods, systems and devices relating to on-boarding users to new features of a device. In some embodiments, methods are disclosed to enable presentation of new device features to users in systematic manner, where new features/functionality is presented to the user at contextually relevant times. For example, instead of forcing a user to learn all new features at once, the methods disclosed herein outline ways of presenting features to users during device use, whereby select features are presented based on what the user is doing with the device. Thus, new device features are identified and introduced to the user in a way that is not out of context or burdensome. In one embodiment, the new device features may not be known to the user and the user may have an interest in exploring and learning more about the new device features. In some embodiments, a training scenario for the new device feature may be provided to the user which enables demonstration use of the new device. In one embodiment, the training scenario for the new device feature can be added to a training scenario interface which can be accessed by the user at any point in time. In one embodiment, the identification of the new device feature can be based on processing user profile data, interactive scenario data, and device feature data through an interactive pathway model which predicts and recommends discovery of new device features to the user.

In one embodiment, a method for on-boarding users to new features of a device is disclosed. In this embodiment, the method includes detecting use of the device by the user during a session. The method includes detecting an interactive scenario during use of the device. The interactive scenario including a plurality of device features usable to move along interactive pathways for the interactive scenario. The method includes identifying the new device feature along a new interactive pathway (i.e., one or more new interactions that may be enabled using a new feature), during said use of the device. In one embodiment, the identifying of the new device feature is based on learning of device features used by the user in one or more prior interactive scenarios. The method, in one embodiment, includes identifying a training scenario for the new device feature. The training scenario is accessible via an interactive interface that enables demonstration use of the new device feature. The new device feature is identified for said training scenario when the new device feature is detected as present as an option along one or more of said interactive pathways. In this way, new device features are introduced to users in a contextual way, such that the new feature can be explored at a time when use of the new feature would be useful or interesting to the user.

In another embodiment, a non-transitory computer-readable storage medium storing a computer program is provided. The computer-readable storage medium includes program instructions for detecting use of the device by the user during a session. The computer-readable storage medium includes program instructions for detecting an interactive scenario during use of the device. The interactive scenario including a plurality of device features usable to move along interactive pathways for the interactive scenario. The computer-readable storage medium includes program instructions for identifying the new device feature along a new interactive pathway during said use of the device. The identifying of the new device feature is based on learning of device features used by the user in one or more prior interactive scenarios. Additionally, the computer-readable storage medium includes program instructions for identifying a training scenario for the new device feature. The training scenario is accessible via an interactive interface that enables demonstration use of the new device feature. The new device feature is identified for said training scenario when the new device feature is present as an option along one or more of said interactive pathways.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The disclosure may be better understood by reference to the following description taken in conjunction with the accompanying drawings in which:

FIG. 1A illustrates an embodiment of a user exploring various features on a device and a notification icon appearing on a display of the user to notify the user that a new device feature has been identified, in accordance with an implementation of the disclosure.

FIG. 1B illustrates an embodiment of a user playing a video game on a device and a notification icon appearing during gameplay of the user to notify the user that a new device feature has been identified, in accordance with an implementation of the disclosure.

FIG. 2 is an embodiment of a system illustrating the various states that a user may be in during the use of a device, in accordance with an implementation of the disclosure.

FIG. 3 illustrates a method for on-boarding users to new features of a device, in accordance with an implementation of the disclosure.

FIG. 4A illustrates an embodiment of an interactive scenario during use of a device by a user, in accordance with an implementation of the disclosure.

FIG. 4B illustrates an embodiment of an interactive scenario during use of a device by a user, in accordance with an implementation of the disclosure.

FIG. 5 illustrates an embodiment of training scenario interface of a user that includes saved feature training and recommended feature training for the user, in accordance with an implementation of the disclosure.

FIGS. 6A-6H illustrate various embodiments of a training scenario of a device feature and its corresponding training session after the user selects a try it option to enable demonstration of the device feature, in accordance with an implementation of the disclosure.

FIG. 7 illustrates an embodiment of a method for using a feature on-boarding processor to identify device features to recommend to a user, in accordance with an implementation of the disclosure.

FIG. 8 illustrates an embodiment of a feature on-boarding processor receiving user profile data, interactive scenario data, and device feature data to process and identify recommended device features for a user, in accordance with an implementation of the disclosure.

FIG. 9 illustrates components of an example device that can be used to perform aspects of the various embodiments of the present disclosure.

### DETAILED DESCRIPTION

The following implementations of the present disclosure provide devices, methods, and systems for on-boarding users to new device features of a device. In particular, the present disclosure presents users with select new device features at contextually relevant times during a user's interaction with a new device or device having new features. In one embodiment, when the new feature is presented, a training scenario for the new device feature may be provided to the user, which enables demonstration use of the new device feature during a session. In other cases, the new device features can be added to a training scenario interface. For example, if the user wishes to learn or try the new feature later, those features can be saved and later accessed via the training scenario interface. Generally, the methods described herein assist users to identify and learn about undiscovered new capabilities of their new device in a frictionless manner.

As used herein, the term “on-boarding” should be broadly understood to refer to discovery and use of new features, learning new features of a new device, system or method, understanding interactive features of a device, system or method, learning how to use features of a device, system or method, setting up features of a device system or method, and/or general use and/or understanding of new features or updates to features or lack of features of a new device, an update to a device or old device, and/or systems or methods having such new, improved or modified features. For purposes of clarity, references to “on-boarding” should be taken in the general broad sense, unless specific examples are described herein.

By way of example, in one embodiment, a method is disclosed that enables on-boarding users to new device features of a device. The method includes detecting use of the device by the user during a session. Broadly speaking, the session may be a time during gaming or a time during user interaction or exploration of the device and/or new features of the device. In one embodiment, a method may further include detecting an interactive scenario during use of the device. The interactive scenario includes a plurality of device features usable to move along interactive pathways for the interactive scenario. The method may further include identifying the new device feature along a new interactive pathway during the use of the device. In one embodiment, the identifying of the new device feature is based on learning of device features used by the user in one or more prior interactive scenarios. As noted above, the method may include identifying a training scenario for the new device feature. The training scenario is accessible via an interactive interface that enables use and/or demonstration use of the new device feature. In one embodiment, a new device feature is identified for the training scenario when the new device feature is present as an option along one or more of the interactive pathways of game play. It will be obvious, however, to one skilled in the art that the present disclosure may be practiced without some or all of the specific details presently described. In other instances, well known process operations have not been described in detail in order not to unnecessarily obscure the present disclosure.

In accordance with one embodiment, a system is disclosed for on-boarding users to new features of a device. In one embodiment, the system may include an operation that detects use of a device by a user, an operation that provides progressive feature on-boarding for the user, and an operation that provides feature training scenario for the user. In one embodiment, the device may be an electronic device such as a video game console, a peripheral, a controller, a television, a computer, a mobile phone, a printer, a tablet, a smart watch, an electronic device, a software feature, or the like. For example, a user purchased a next generation video game console and wants to set up the video game console and learn about the new device features and capabilities that are available on the video game console. In one embodiment, the system detects the user's use of the device and as the user begins to use the console, the system initiates a progressive feature of on-boarding operation so that the user can learn about the new features available on the next generation video game console. As noted above, presenting of new features may be processed in a progressive manner, where features that may be useful to use are presented in contexts of use where learning the feature would be useful to the user.

In accordance with another embodiment, as the user explores and interacts with the device, the system can detect an interactive scenario associated with the actions taken by the user during the user's interaction with the device. The interactive scenario may include a plurality of device features and a new device features along various pathways taken by the user. In some embodiments, as the user interacts with the device, a notification icon may appear and notify the user that a new device feature has been identified. In one embodiment, the user may learn more about the new device feature via a training scenario for the new device feature. In one embodiment, the user can ignore the notification icon and add/save the training scenario to an interactive scenario interface which can be accessed by the user at a later time. In some embodiments, the interactive scenario interface may include a plurality of new device features that were added by the user during the interactive scenario. In another embodiment, the interactive scenario interface may include a plurality of recommended new features training based on the interests of the user.

With the above overview in mind, the following provides several example figures to facilitate understanding of the example embodiments.

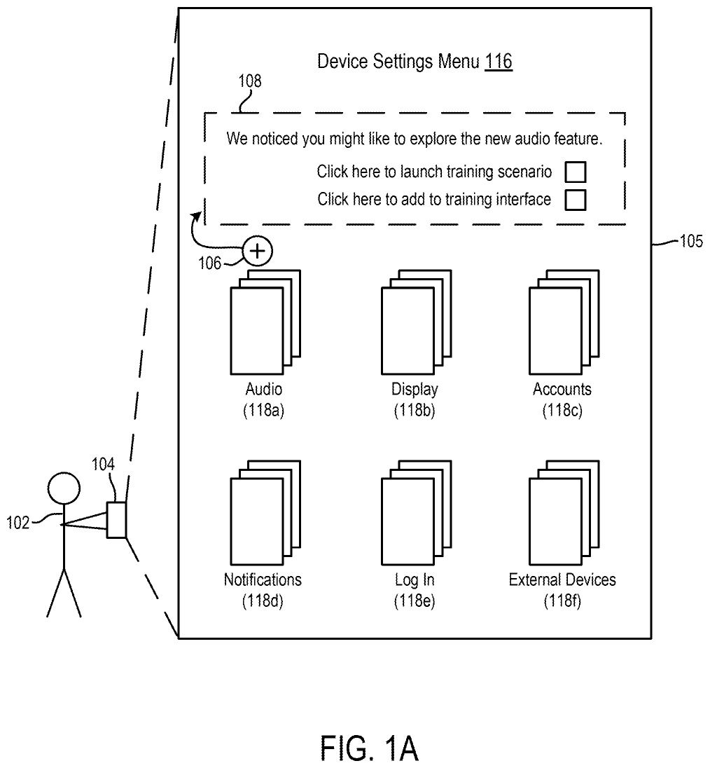

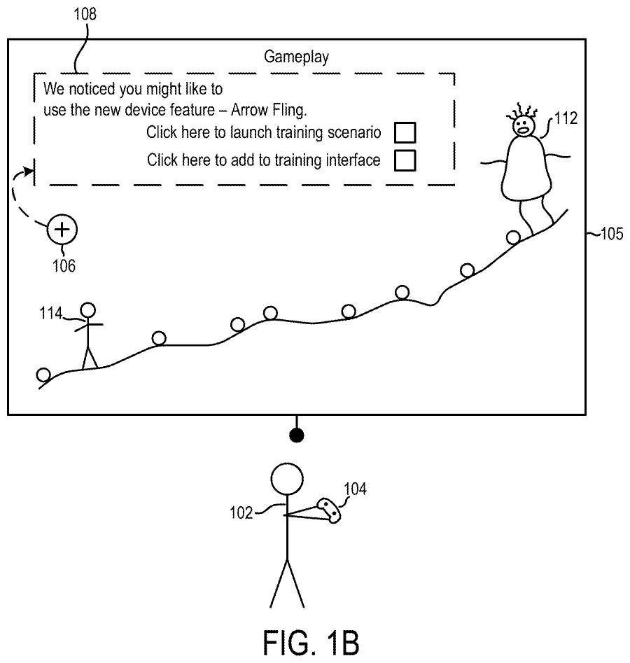

FIG. 1A illustrates an embodiment of a user 102 exploring various features on a device 104 and a notification icon 106 appearing on a display 105 of the user 102 to notify the user that a new device feature has been identified. According to the embodiment shown in FIG. 1A, a user 102 is shown using a device 104 and exploring various features associated with the device 104. In some embodiments, the device 104 may be a computer or special purpose computer known in the art, but not limited to, a gaming console, a personal computer, a laptop, a tablet computer, a monitor and console/PC setup, a television and console setup, a mobile device, a controller, a peripheral device, a tablet, a thin client, a set-top box, a media streaming device, a network device/appliance, etc. In the illustrated example, as shown on the display 105 of the device 104, the user 102 is shown exploring a device settings menu 116. In some embodiments, the device settings menu 116 may include various setting categories (e.g., 118a-118f) which can be configured by the user 102 to align with the user's preferences. As illustrated, the setting categories may include an audio setting 118a, a display setting 118b, an accounts setting 118c, a notifications setting 118d, a login setting 118e, and an external devices setting 118f. It should be understood that the menu and graphical user interface may take on various forms and layouts, and this illustration is provided to show the interactive nature of feature onboarding.

In some embodiments, while the user interacts with the device and explores the various features on the device 104, a notification icon 106 may appear on the display 105 of the device to notify the user 102 that a new device feature has been identified. In one embodiment, the new device feature may be a feature that is new to the user 102 or device, or which the user 102 is unfamiliar with and has not used before. The new device feature may be a device feature that is specifically available on the device 104 that the user is using and one that was unavailable on previous versions of the device. For example, the user may be using a device 104 that was recently released (e.g., next generation gaming console). Again, device 104 should be broadly construed to be any type of device that may be a new feature or features that can be on-boarded for a specific user. The specific user, in one embodiment, is a user having a user account and profile, and information regarding past used features may be stored. In other examples, the user's profile may not include past used features, but since the feature is newly released it can be inferred that the user has not used the feature in the past. In one example, the new device feature may be a feature that is specifically available on the next generation gaming console and was not available on previous versions of the gaming console.

In one embodiment, as the user 102 navigates through the device 104 to explore various features associated with the device, a notification icon 106 may appear on the display 105 of the user's device to notify the user that a new device feature has been identified. In one embodiment, the size of the notification icon 106 may be large enough to grab the attention of the user 102, however, the notification icon 106 may be subtle not interfere with the user's interaction of the device. In other words, the notification icon 106 may not distract the user from the user's interaction with the device and will allow to the user to continue interacting with the device. In some embodiments, when the user clicks on the notification icon 106, a notification message 108 may be displayed which provides additional information associated with the new device feature. For example, as shown in FIG. 1A, when the user 102 clicks on the notification icon 106, the notification message 108 includes a message stating, “We noticed you might like to explore the new audio feature. Click here to launch training scenario. Click here to add to training interface.” In other embodiments, when the notification icon 106 appears on the display 105 of the user, the user may ignore the notification icon 106. In such cases, the notification icon 106 may fade away and disappear from the display 105, and the new device feature can be automatically added to the training interface for the user to access and explore at a later time.

FIG. 1B illustrates an embodiment of a user 102 playing a video game on a device 104 and a notification icon 106 appearing during gameplay of the user to notify the user that a new device feature has been identified. In one embodiment, FIG. 1B illustrates a user 102 playing a video game that is displayed on a display 105. As shown on the display 105, the user 102 is represented by avatar 114. The scene in the gameplay shows the avatar 114 of the user walking up a hill and approaching a boss character 112. In order advance onto the next stage in the game, the user 102 needs to defeat the boss character or figure out how to maneuver around the boss character 112. In one embodiment, during the gameplay, the system automatically detects the interactive scenario that the user is in and a plurality of various device features that can be used during the session. In some embodiments, the device features can be features that are known to the user or new device features that the user is unfamiliar with.

For example, as shown in FIG. 1B, the interactive scenario may be the particular scene in the gameplay that the user 102 is playing in (e.g., boss character scene), and the device features may include various offensive strategies that the user 102 can utilize to challenge the boss character or advance in the game. In one example, the device features may include features such as holding on the controller's R1 and R2 buttons to swing the user's sword at faster speed and to enable haptic feedback on the controller, double tapping on the controller's square button to pick up a rock to throw it at the boss character, etc. As noted above, the user 102 may already be familiar with the device features and know how to use the device features within the corresponding interactive scenario. In other embodiments, the interactive scenario may include new device features that the user 102 may not be familiar with. In some embodiments, the user may click on the notification icon 106 and a notification message 108 which provides additional information associated with the new device feature. Further, one advantage of surfacing features when they are contextually useful makes for a low friction way of learning new features.

As illustrated in the example in FIG. 1B, when the user clicks (i.e., provides input of any sort) on the notification icon 106, a notification message 108 appears with the message, “We noticed you might like to use the new device feature—Arrow Fling. Click here to launch training scenario. Click here to add to training interface.” As noted above, the user 102 may choose to ignore the notification icon 106. Accordingly, the notification icon 106 may fade away and disappear from the display 105, and the new device feature (e.g., Arrow Fling) can automatically be added to the training interface for the user to access and explore at a later time.

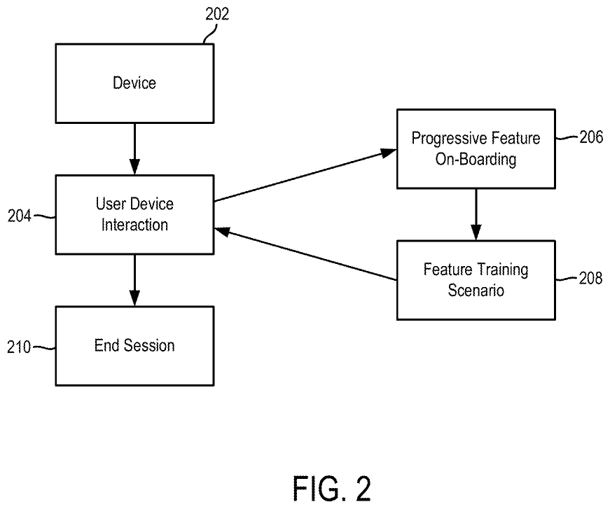

FIG. 2 is an embodiment of a system illustrating the various states that a user 102 may be in during the use of a device 104. In one embodiment, FIG. 2 illustrates a device 202 state, a user device interaction 204 state, a progressive feature on-boarding 206 state, a feature training scenario 208 state, and an end session 210 state. In one embodiment, at the device 202 state, the user 102 may be activating a device 104 such as a new device that was recently acquired by the user. In some embodiments, the device 104 may be an electronic device such as a video game console, a peripheral, a controller, a television, a computer, a mobile phone, a printer, a tablet, a smart watch, glasses, a head mounted display (HMD), a network device, a dongle, a personal computer (PC), an electronic device, etc.

At the user device interaction 204 state, the system can detect the user 102 interacting with the device 104. For example, the user device interaction 204 state may include the user actions associated with the device such as the user navigating through the device 104 to explore various features and capabilities on the device, the user playing a video game using the device, the user playing music using the device, the user taking pictures using the device, the user viewing video content on the device, the user sending a text message using the device, etc. After the system detects that the user 102 is interacting with the device, the user may transition to the progressive feature on-boarding 206 state where the progressive feature on-boarding is initiated.

At the progressive feature on-boarding 206 state, the system may detect an interactive scenario and a plurality of device features along pathways of the interactive scenario, and during the use of the device, the system may identify new device features along the pathways. As noted above, a pathway may be a path of device use, i.e., features that may be used to make use of the device, setup the device, or advance in setup of the device, or advance in interactive use in a game or computing session. As noted above, a notification icon 106 may appear on the display of the user's device to notify the user that new device features have been identified. In one embodiment, the user 102 may launch a training scenario for the new device feature that demonstrates the use the new device feature. In some embodiments, the user may add the training scenario of the new device feature to a training scenario interface which can be accessed by the user at any desired time. Once the new device feature is identified, the user may transition to the feature training scenario 208 state where the user can initiate a training scenario associated with the new device feature to learn how to use the new device feature.

At the feature training scenario 208 state, the user may access a training scenario associated with the new device feature to learn how to use the new device feature. In some embodiments, the training scenario may include a video option that demonstrates the new device feature. In other embodiments, the training scenario may allow the user to practice using the feature by initiating a try it option. In one embodiment, when the try it option is selected by the user, the user may enter a training session which is gamified and walks the user through the process of teaching the user how to use the new device feature. In some embodiments, when the user 102 accesses the feature training scenario while interacting with the device, the session of use of the device may be temporarily put a pause to allow the user to interact with the training scenario.

In one embodiment, allowing the session to be put on pause enables the user's demonstration of the training scenario without affect the state of the session. Once the feature training scenario has ended, the user may resume interacting with the device. The state of the user transitions to the user device interaction 204 state and the system continues to detect the user 102 interacting with the device 104. In one embodiment, the system may determine that the user is no longer interacting with the device 104. Accordingly, when the user no longer interacts with the device 104, the state of the user transitions to the end session 210 state.

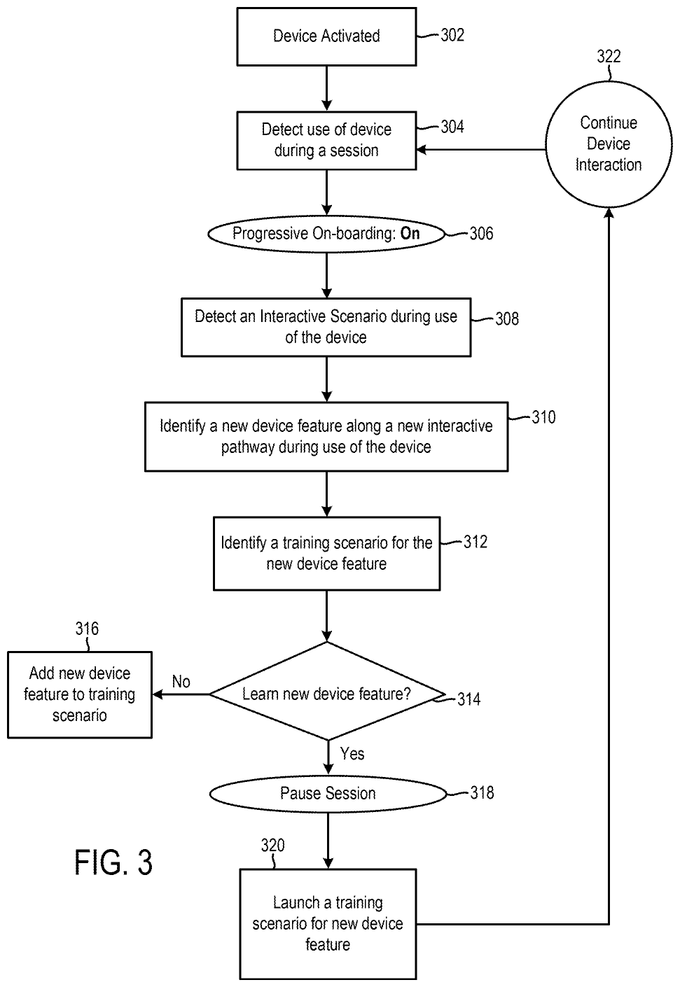

FIG. 3 illustrates a method for on-boarding users 102 new features of a device 104. In one embodiment, the method includes an operation 302 that detects when a device is activated. The method flows to operation 304 where the operation is configured to detect the use of the device during a session. For example, the user 102 purchased a new video game console and proceeds to register and to activate the video game console according to the device's registration instructions. After activating the video game console, the user begins to use the device and navigates through the device features to explore the capabilities of the device, e.g., friends list, sound and device settings, Share Play, Spotify music playback settings, power and restart options, etc. Upon using the device, the system detects the use of the device and the operation flows to progressive on-boarding 306 operation where the operation is configured to initiate progressive on-boarding for the user 102.

Once the progressive on-boarding 306 operation is activated (e.g., ON or active), the method flows to operation 308 where the operation is configured to detect an interactive scenario during use of the device. In some embodiments, the interactive scenario 402 may include the context of the scenario and describe how the user 102 interacts with a device 104. In one embodiment, the interactive scenario includes a plurality of device features that are usable to move along interactive pathways for the interactive scenario. For example, a user may be interacting with their mobile phone device and navigating through a device settings category related to external devices. As the user navigates through the settings category (e.g., external devices) along an interactive pathway, the system automatically detects the interactive scenario associated with the use of the device. In this example, the interactive scenario may include a plurality of device features along the interactive pathway taken by the user such as printing options, multi-screen mirroring, activating Bluetooth, paring the device with existing devices (e.g., headphones, home entertainment system, vehicle stereo system, etc.), paring the device with new devices, etc. In one embodiment, the device features along the interactive pathway are features that are known to the user and based on the user's previous interactions with the features.

The method flows to operation 310 where the operation is configured identify a new device feature along a new interactive pathway during use of the device. In one embodiment, new device features may be identified along a new interactive pathway that branches off of an existing interactive pathway of the interactive scenario. The new device features may be one or more features that the user is not familiar with nor had any prior interactions with. For example, as noted in the example above, as the user navigates through the settings category (e.g., external devices) on their mobile phone device, the system may identify a new device feature such as a QR code-based paring, etc. This new device feature may be a new feature that the user is unfamiliar with and may have an interest in learning more about.

In one embodiment, the identification of the new device feature can be based on processing user profile data, interactive scenario data, and device feature data through an interactive pathway model. In some embodiments, the interactive pathway model is configured to identify features from the user profile data, the interactive scenario data, and the device feature data to classify the features using one or more classifiers. The classified features are then used by the interactive pathway model to predict and identify new device features that the user might be interested in and would help the user learn more about the device.

At operation 312, the operation is configured to identify a training scenario for the new device feature. The training scenario may be accessible by the user 102 and is configured to enable demonstration use of the new device feature. As noted above, the training scenario may include a video option that is selectable by the user which provides a video demonstration explaining what the new device feature does and how to use the new device feature. In other embodiments, the training scenario may include a try it option that is selectable by the user and is configured to allow the user to practice using the new device feature. When the try it option is selected by the user, the user may enter a training session which is gamified and walks the user through a step-by-step process on how to use the new device feature while allowing the user to practice using the new device feature. In one embodiment, the training scenario is accessible via a scenario training interface that includes a list of various new device feature training scenarios and recommended feature training scenarios that are selectable by the user for demonstration use of the feature.

In some embodiments, the training scenario is usable via a secondary device (e.g., a smartphone or tablet, or other computer). The secondary device may enable demonstration use of the new device feature. For example, the user may be shopping at a grocery store and waiting in line to checkout. The user may use a secondary device such as a mobile phone device to access training scenarios for new device features associated with a video game console to learn about its new capabilities.

The method flows to operation 314 where the operation is configured to determine whether the user 102 wants to learn how to use the new device feature during the interactive scenario. For example, during a gameplay of the user, the system may identify a new device feature that relates to using a bow and arrow weapon to attack an enemy character in the game. If the user decides to learn the new device feature, the method flows to operation 318 where the operation pauses the session of the game. However, if the user declines to learn the new device feature, the method flows to operation 316 where the operation is configured to add the new device feature to a training scenario interface which can be accessed by the user at any desired time.

At operation 318, the operation is configured to pause the content being used via the device and the session of the user's interaction with the device. This allows the user to resume interacting with the device from a point where the user left off without affecting a state of the content. After the session is paused, the method flows to operation 318 where the operation is configured to launch a training scenario for the new device feature. As noted above, the training scenario allows the user to learn how to use the new device feature. In some embodiments, the training scenario provides the user with an option to watch a video demonstration of the new device feature and an option to try out to feature so that the user can learn how to use the new device feature. After the user completes the training scenario and exits the training scenario, the user can continue interacting with the device (e.g., operation 322) from the point where the session was paused and the method continues to operation 304 where the operation is configured to continue detecting the use of the device during a session.

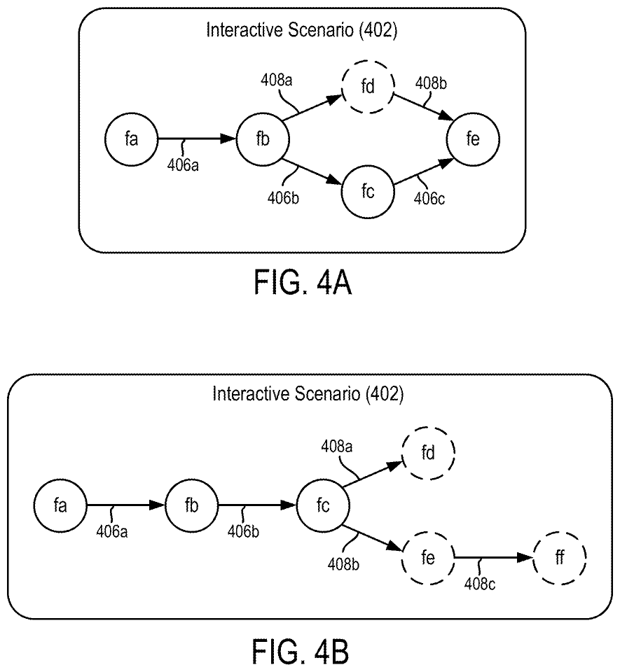

FIG. 4A illustrates an embodiment of an interactive scenario 402 during use of a device 104 by a user 102. As illustrated in the figure, the interactive scenario 402 includes a plurality of device features (e.g., fₐ, f_{b}, f_{c}, fₑ) along interactive pathways (e.g., 406a, 406b, 406c), and a new device feature f_{d} along a new interactive pathway 408a. In one embodiment, the interactive scenario 402 describes how the user 102 interacts with a device 104. The interactive scenario 402 can include various pathways (e.g., interactive pathway and new interactive pathway) taken by the user as the user navigates through the device and various device features are included along the pathways that the user can interact with. To illustrate the interactive scenario 402, in one example, as illustrated in FIG. 4A, the interactive scenario 402 can be a scenario of the user 102 interacting with a device such as a new mobile phone to configure settings related to external devices.

As the user 102 navigates through the settings, the user may first encounter device feature fₐ which is a feature related to multi-screen mirroring. In one embodiment, if the user is already familiar with the device feature fₐ or the user does not have an interest in exploring it, the user may continue to navigate along the interactive pathway 406a. As the user continues to move along the interactive pathway 406a, the user encounters device feature f_{b} which may be a feature related to activating external device. While at device feature f_{b}, the user can explore the device feature f_{b}, and then proceed to move along the interactive pathway 406b toward device feature f_{c}, or continue along new interactive pathway 408a toward new device feature f_{d}.

In one embodiment, the user 102 can continue to move along the interactive pathway 406b toward device feature f_{c} which may be a feature related to activating external device via Bluetooth. However, the user may move along the new interactive pathway 408a toward the new device feature f_{d} which may be a feature related to activating external device using a QR Code. Since the new device feature f_{d} is a feature that the user is unfamiliar with and a feature that the user is interested in exploring, the user may decide to move along the new interactive pathway 408a to learn how to use the new device feature f_{d}. In some embodiments, the system may launch a training scenario for the new device feature f_{d} which includes an option for watching a video demonstration on how to use the new device feature f_{d}, or an option that provides step-by-step instructions and allowing the user to learn how to use the new device feature.

In one embodiment, if the user is at the device feature f_{c}, or at the new device feature f_{d}, the user can move toward device feature fₑ along interactive pathway 406c and new interactive pathway 408b, respectively. In one embodiment, the device feature fₑ can be a feature related to configuring audio settings for external devices. Accordingly, the interactive scenario 402 may include a plurality of device features along interactive pathways of the interactive scenario. In addition, the interactive scenario 402 may also include new device features along new interactive pathways that branches off from the interactive pathways.

FIG. 4B illustrates an embodiment of an interactive scenario 402 during use of a video game console device 104 by a user 102. As illustrated in the figure, the interactive scenario 402 includes a plurality of device features (e.g., fₐ, f_{b}, f_{c}) along interactive pathways (e.g., 406a, 406b), and new device features (f_{d}, fₑ, f_{f}) along new interactive pathways (408a-408c). As noted above, the interactive scenario 402 describes how the user 102 interacts with a device 104 such as a video game console. The interactive scenario 402 can include various pathways taken by the user as the user operates the device or plays a game on the device. In one example, as illustrated in FIG. 4B, the interactive scenario 402 can be a scenario of the user 102 during a gameplay that includes a scene of a user approaching a warzone to fight enemy soldiers.

As the user approaches the game scene involving a warzone fight, the user may first encounter device feature fₐ which is a feature related to climbing hills at faster pace. The user may be familiar with the device feature fₐ and continues along interactive pathway 406a toward device feature f_{b} which is a feature related to dodging enemy bullets. As the user progresses along interactive pathway 406b, the user encounters device feature f_{c} which is a feature related to health regeneration.

While the user is at device feature f_{c}, the user can move along new interactive pathway 408a or new interactive pathway 408b to reach new device feature f_{d} or new device feature fₑ, respectively. In one embodiment, new device feature f_{d} may be a defense feature related to using an armor plate. However, if the user moves toward new device feature fₑ, and device feature f_{f}, the features may be related to the use of weapons such as a sniper and a grenade launcher, respectively. As noted above, in some embodiments, each new device feature (f_{d}, fₑ, f_{f}) may include a corresponding training scenario that allows the user to watch a video demonstration of the new device feature and an option to learn how to use the new device feature. Accordingly, the interactive scenario 402 may include a plurality of device features along interactive pathways of the interactive scenario. In addition, the interactive scenario may also include new devices features along a new interactive pathway that branches off from the interactive pathway.

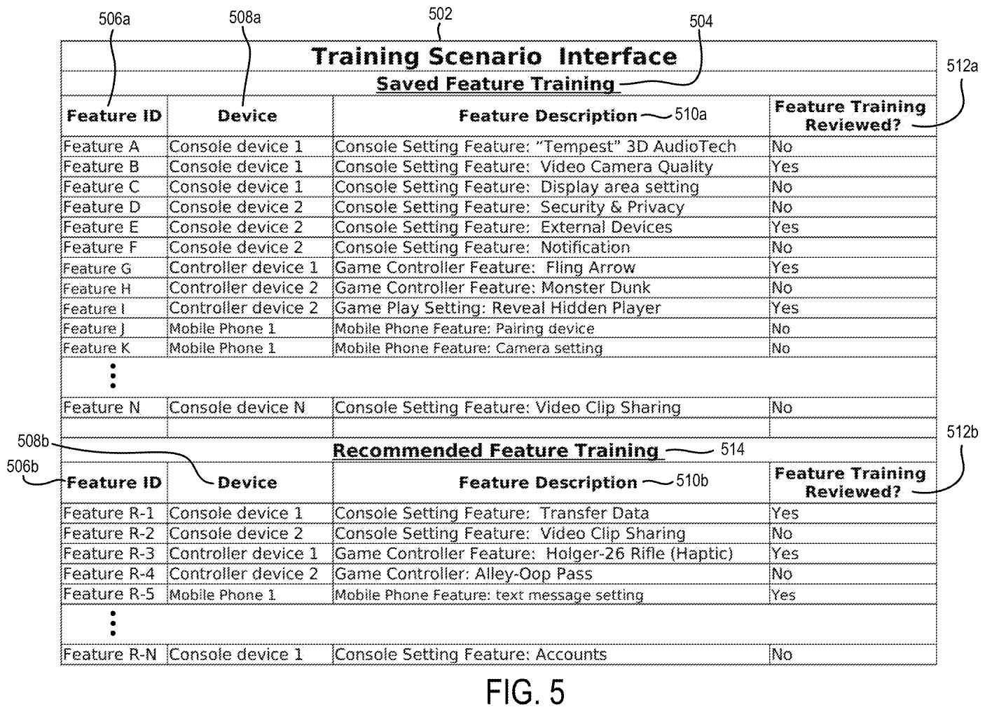

FIG. 5 illustrates an embodiment of training scenario interface 502 of a user 102 that includes saved feature training 504 and recommended feature training 514 for the user 102. In one embodiment, the training scenario interface 502 may include a plurality of saved feature training and a corresponding feature identification 506a for each feature training, a device type 508a associated with the saved feature training, a feature description 510a associated with the corresponding saved feature training, and a tracker that tracks whether the saved feature training has been reviewed (e.g., 512a). As noted above, as the user 102 interacts with a device 104 during a session, the system identifies new device features which can be saved to the training scenario interface 502 and accessed by the user at a later time. In some embodiments, the device 104 may be an electronic device such as a video game console, peripheral, controller, television, computer, mobile phone, printer, tablet, smart watch, etc.

As illustrated in FIG. 5, the training scenario interface 502 includes a plurality of saved feature trainings that corresponds to a specific device used by the user. For example, Feature A involves a “Tempest” 3D audio feature which may be configured and applied on console device 1 to enhance the audio experience of the device. In one embodiment, when the user selects Feature A to explore and learn more about the device feature, the system may launch a training scenario for Feature A and the user can watch a video demonstration of the feature. In addition, the user can try out the feature and learn how to use it. As further illustrated in FIG. 5, the training scenario interface 502 may include additional saved feature trainings such as video camera quality (e.g. Feature B, Console device 1), display area setting (e.g. Feature C, Console device 1), security & privacy (e.g. Feature D, Console device 2), external devices (e.g. Feature E, Console device 2), etc. Similar to Feature A, when the user selects a specific saved feature training to explore and learn more about, the system may launch a training scenario for the corresponding saved feature training to enable a demonstration of the feature. In some embodiments, as the user selects and learns how to use a specific feature, the system keeps track and notes whether the feature training has been reviewed by the user, e.g., 512a.

As further illustrated in FIG. 5, in another embodiment, the training scenario interface 502 may include a plurality of recommended feature training 514 for the user 102. As illustrated, each recommended feature training includes a feature identification 506b, a device type 508b associated with the recommended feature training, a feature description 510b associated with the corresponding recommended feature training, and a tracker that tracks whether the recommended feature training has been reviewed (e.g., 512b). For example, the recommended feature training 514 may include feature training such as transferring data (e.g., Feature R-1, Console device 1), video clip sharing (e.g., Feature R-2, Console device 2), enabling haptic feedback for a Holger-26 rifle in a game (e.g., Feature R-3, Controller device 1), etc. As noted above, when the user selects a specific recommended feature training to explore and learn more about, the system may launch a training scenario for the corresponding recommended feature training so that the user can learn more about the feature. In some embodiments, as the user selects and demonstrates how to use a specific feature, the system keeps track and notes whether the feature training has been reviewed by the user, e.g., 512b.

In some embodiments, the recommended feature training for inclusion into the training scenario interface 502 is based on processing user profile data, interactive scenario data, and device feature data through an interactive pathway model. The interactive pathway model is configured to identify features from the user profile data, the interactive scenario data, and the device feature data to classify the features using one or more classifiers. The classified features are then used by the interactive pathway model to predict and identify recommended feature training that the user might be interested in learning.

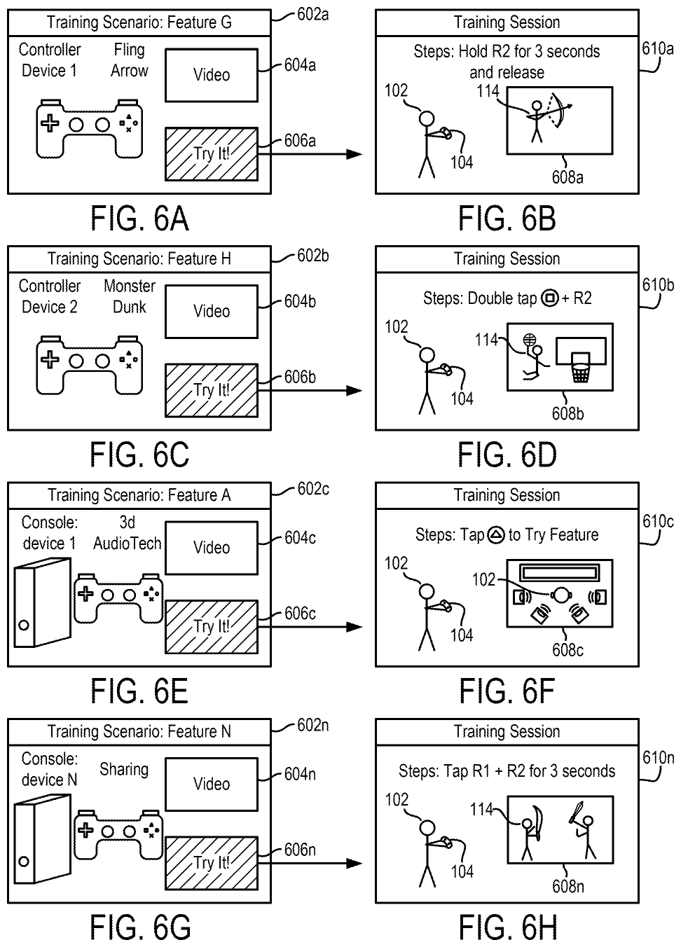

FIGS. 6A-6H illustrate various embodiments of a training scenario of a device feature and its corresponding training session after the user selects a try it option to enable demonstration of the device feature. In one embodiment, each training scenario (e.g., 602a, 602b, 602c, 602n) may include a video option (e.g., 604a, 604b, 604c, 604n) that provides a video demonstration explaining and describing what the device feature does. In another embodiment, each training scenario (e.g., 602a, 602b, 602c, 602n) may include a try it option (e.g., 606a, 606b, 606c, 606n) that can walk the user through a step-by-step process and allow the user to practice and learn how to use the device feature.

In one embodiment, as shown in FIGS. 6A and 6B, the figures illustrate the training scenario 602a and its corresponding training session 610a after the user selects the try it option 606a to enable demonstration of the device feature. In one embodiment, as shown in FIG. 6A, the training scenario 602a is for device Feature G which involves a “Fling Arrow” feature for controller device 1. As illustrated, the user may select the video option 604a to watch a video demonstration explaining and describing the “Fling Arrow” feature, or the try it option 606a which launches the training session 610a. In some embodiments, the training session 610a is gamified and walks the user through a step-by-step process on how to use the new device feature and allows the user to practice using the device feature. This allows the user to master or to become comfortable using the device feature before resuming with the use of the device.

As shown in FIG. 6B, after selecting the try it option 606a, the user 102 may enter a training session 610a and learn how to use the new device feature. As illustrated, the training session 610a may include instructions showing the user 102 how to use the feature e.g., Steps: Hold R2 for 3 seconds and release. The user 102 is shown using a device 104 (e.g., controller) practicing the “Fling Arrow” feature. When the user follows the noted steps, the controller of the user may vibrate as a response to shooting the arrow. In some embodiments, the training session 610a may also include a monitor 608a which shows the avatar 114 of the user shooting an arrow as the user practices using the feature on the device.

In another embodiment, as shown in FIGS. 6C and 6D, the figures illustrate the training scenario 602b and its corresponding training session 610b after the user selects the try it option 606b to enable demonstration of the device feature. In one embodiment, as shown in FIG. 6C, the training scenario 602b is for device Feature H which involves a “Monster Dunk” feature for controller device 2. As illustrated, the user may select the video option 604b to watch a video demonstration explaining and describing the use of the “Monster Dunk” or the try it option 606b which launches the training session 610b.

As shown in FIG. 6D, after selecting the try it option 606b, the user 102 may enter a training session 610b and learn how to use the new device feature. As illustrated, the training session 610b may include instructions showing the user 102 how to use the feature e.g., Steps: Double tap square button and hold R2. In FIG. 6D, the user 102 is shown using a device 104 (e.g., controller) and practicing the “Monster Dunk” feature. In some embodiments, the training session 610b may also include a monitor 608b which shows the avatar 114 of the user dunking a basketball as the user practices using the feature on the device.

In one embodiment, as shown in FIGS. 6E and 6F, the figures illustrate the training scenario 602c and its corresponding training session 610c after the user selects the try it option 606c to enable demonstration of the device feature. In one embodiment, as shown in FIG. 6E, the training scenario 602c is for device Feature A which involves enabling the “3D Audiotech” feature for console device 1. As illustrated, the user may select the video option 604c to watch a video demonstration explaining and describing the “3D Audiotech” feature, or the try it option 606c which launches the training session 610c.

As shown in FIG. 6F, after selecting the try it option 606c, the user 102 may enter a training session 610c and learn how to enable the new device feature. As illustrated, the training session 610c may include instructions showing the user 102 how to enable the feature e.g., Steps: tap the triangle button to enable the feature. In FIG. 6F, the user 102 is shown using a device 104 to enable the “3D Audiotech” feature and experiencing the feature upon activating the feature (e.g., 608c).

In another embodiment, as shown in FIGS. 6G and 6H, the figures illustrate the training scenario 602n and its corresponding training session 610n after the user selects the try it option 606n to enable demonstration of the device feature. In one embodiment, as shown in FIG. 6G, the training scenario 602n is for device Feature N which involves a “sharing” feature for console device N. As illustrated, the user may select the video option 604n to watch a video demonstration explaining and describing how to use of the “sharing” feature, or the try it option 606n which launches the training session 610n.

As shown in FIG. 6H, after selecting the try it option 606n, the user 102 may enter a training session 610n and learn how to use the new device feature. As illustrated, the training session 610n may include instructions showing the user 102 how to use the feature e.g., Steps: Tap R1 and R2 for 3 seconds. In FIG. 6H, the user 102 is shown using a device 104 and practicing the “sharing” feature. In some embodiments, the training session 610b may also include a monitor 608n which shows the avatar 114 in a sword fight and the user 102 practicing the “sharing” feature on the device.

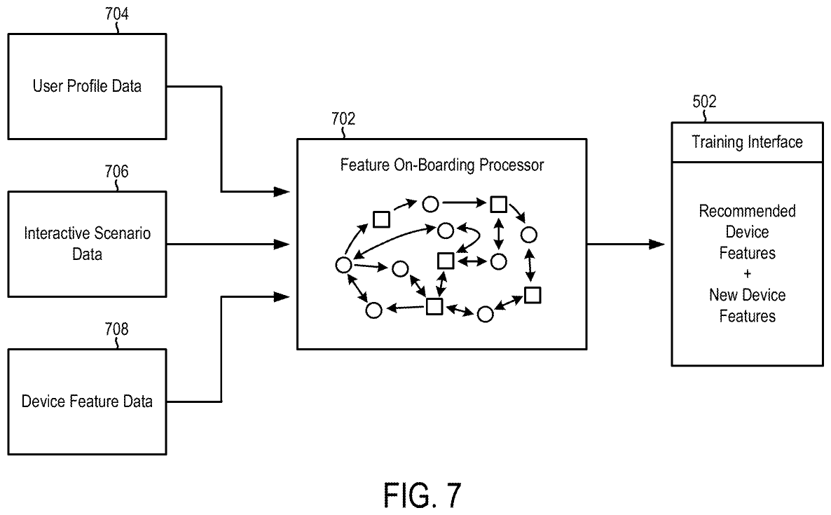

FIG. 7 illustrates an embodiment of a method for using a feature on-boarding processor 702 to identify device features to recommend to a user 102. As the user 102 uses a device 104, the feature on-boarding processor 702 may introduce the recommended device features to the user 102 as the user 102 interacts with the device 104 during the interactive scenario 402. During the interactive scenario 402, the recommended device features can be introduced to the user as a new device feature (e.g., f_{d}, fₑ, f_{f}) within the interactive scenario 402. In some embodiments, the feature on-boarding processor 702 may identify device features to recommend to the user 102 which may be included into the training scenario interface 502 for the user to access (e.g., recommended feature training 514). In one embodiment, the feature on-boarding processor 702 implements one or more machine learning operations that ingest user profile data 704, interactive scenario data 706, and device feature data 708 to process and identify device features for the user.

In one embodiment, the user profile data 704 may include attributes and characteristics of the user 102 such as gender, age, device use experience, device use history, gaming experience, gameplay history, viewing history, gaming skill level, preferences, interests, disinterests, etc. In one embodiment, the profile data 704 may include a history of interactive use of the device and other devices that the user has interactive with in the past. In another embodiment, the interactive scenario data 706 may be include a variety of information associated with the interactive scenario as the user 102 uses, interacts, and navigates through various features on the device 104. For example, the interactive scenario data 706 may include information related to the type of device 104 (e.g., video game console, controller, mobile phone, etc.) the user is interacting with, the context of the interactive scenario (e.g., configuring a device setting, playing a single player or multiplayer video game, etc.), actions performed by the user, specific interactions with the device, (e.g., specific features the user is exploring and using), etc. In another embodiment, the device feature data 708 may include information associated with the devices used by the user such as the new device features for that are available on a particular device. For example, if a user interacts with a gaming console, mobile device, controller, and a printer, the device feature data 708 may include information related to all of the features (e.g., existing features and new features) that are available on each device.

In another embodiment, the feature on-boarding processor 702 may process the above noted inputs to identify features and classify the features using one or more classifiers. The classified features are then used by a machine learning engine to predict various device features to introduce to a user. As noted above, the device features may be introduced to the user as the user interacts with the device, or the features can be recommended to the user and included into the training scenario interface 502 of the user.

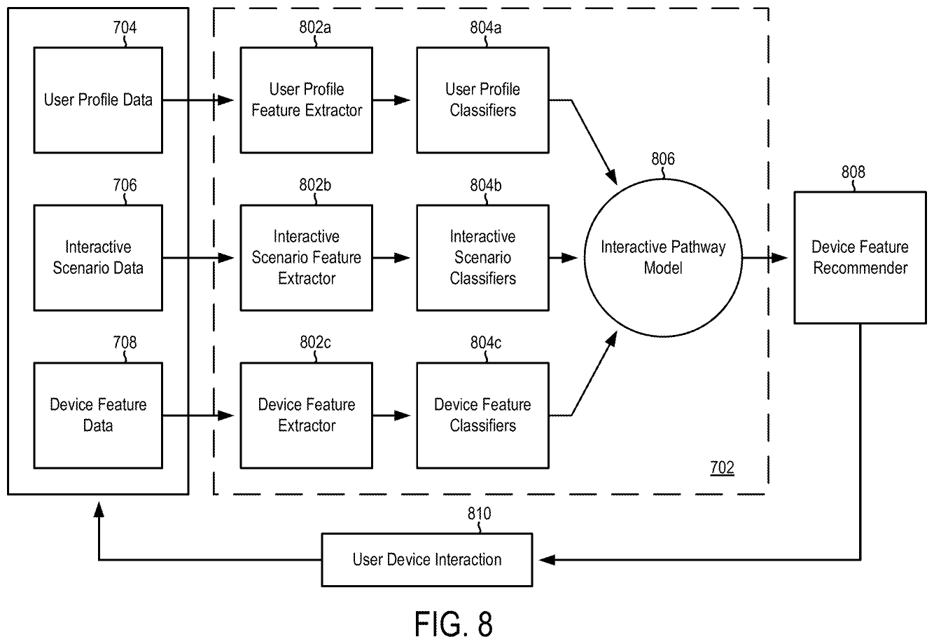

FIG. 8 illustrates an embodiment of a feature on-boarding processor 702 receiving user profile data 704, interactive scenario data 706, and device feature data 708 to process and identify recommended device features for a user 102. As noted above, the recommended device features may be introduced to the user as a new device feature (e.g., f_{d}, fₑ, f_{f}) during the user's interactive scenario 402. In other embodiments, the recommended device features may be included into the training scenario interface 502 for the user to access at any desired time.

As shown in FIG. 8, in one embodiment, the on-boarding processor 702 may include feature extraction 802a-802c operations that are configured to identify various features in the profile data 704, the interactive scenario data 706, and the device feature data 708, respectively. After the feature extraction 802a-802c operations identifies the features associated with the inputs, classifier operations 804a-804c may be configured to classify the features using one or more classifiers. In some embodiments, the feature on-boarding processor 702 includes an interactive pathway model 806 that is configured to receive the classified features (e.g., user profile classified features, interactive scenario classified features, device feature classified features) from the classifier operations 804a-804c. Using the classified features, the interactive pathway model 806 can be used to identify recommended device features for the user 102. A device feature recommender 808 can use the interactive pathway model 806 to determine which device features to recommend to the user 102. After the device features are recommended and introduced to the user 102, a user device interaction 810 operation can determine whether the user has reviewed or accessed the training scenario of the device feature.

In one embodiment, the system can process the user profile data 704. As noted above, the user profile data may include attributes and characteristics of the user such as gender, age, device use experience, device use history, gaming experience, gameplay history, viewing history, gaming skill level, preferences, interests, disinterests, etc. In some embodiments, the feature extraction 802a is configured to process the user profile data 704 data to identify and extract features associated with the profile of the user. By way of example, these features may include the various types of devices the user has experience using in the past, the level of experience using a particular device (e.g., beginner, intermediate, expert), particular device features that the user uses more frequently than others, etc. After the feature extraction 802a processes and identifies the features from the user profile data 704, the classifier operation 804a is configured to classify the features using one or more classifiers. In one embodiment, the features are labeled using a classification algorithm for further refining by the interactive pathway model 806.

In another embodiment, the system can process the interactive scenario data 706. As noted above, the interactive scenario data 706 may be include a variety of information associated with the interactive scenario of the user 102 when the user uses, interacts, and navigates through various features of the device 104. In some embodiments, the feature extraction 802b operation is configured to process the user interactive scenario data 706 to identify and extract features associated with the interactive scenario of the user. After the feature extraction 802b processes and identifies the features from the interactive scenario data 706, the classifier operation 804b is configured to classify the features using one or more classifiers.

In another embodiment, the system can process the device feature data 708. In some embodiments, the device feature data 708 may include information associated with the devices used by the user. In some embodiments, the feature extraction 802c operation is configured to process the device feature data 708 to identify and extract features associated with the devices that the user interacts with. After the feature extraction 802c processes and identifies the features from the device feature data 708, the classifier operation 804c is configured to classify the features using one or more classifiers.

In some embodiments, the interactive pathway model 806 is configured to receive as inputs the classified features (e.g., user data profile classified features, interactive scenario data classified features, device feature data classified features). In another embodiment, other inputs that are not direct inputs or lack of input/feedback, may also be taken as inputs to the interactive pathway model 806. The interactive pathway model 806 may use a machine learning model to predict recommended device features for the user 102. For example, the interactive scenario data my indicate that the user is playing a game that involves a combat scene against enemy characters, and the user data profile may indicate that the user has never used the bow and arrow weapon feature in the game. Using the device feature data, the interactive pathway model 806 may predict various device features related to the use of the bow and arrow weapon to recommend to the user (e.g., aiming and firing, zooming onto target, enabling controller haptic feedback, etc.). In some embodiments, the interactive pathway model 806 may recommend and predict the most effective device feature to use for a particular interactive scenario. For example, although the user may be interested and prefer to use the bow and arrow weapon during the combat scene, the model may suggest other weapons that may be more effective given the particular context of the scenario.

In some embodiments, the device feature recommender 808 can use the interactive pathway model 806 to determine which device features to recommend to the user 102. The device feature recommender 808 may decide to introduce the recommended device feature as a new device feature to the user while the user interacts with the device during an interactive scenario 402. In other embodiments, device feature recommender 808 may recommend that the device feature is included into the training scenario interface 502 for the user to access at any desired time. In one embodiment, after the device feature recommender 808 recommends a device feature to the user, the user device interaction 810 operation can be configured to keep track and determine whether the user has reviewed or accessed the training scenario of the device feature. Once the user has completed the training scenario for the device feature, the output of the user device interaction 810 operation can be used as feedback to the system to inform the system which device features have been reviewed by the user.

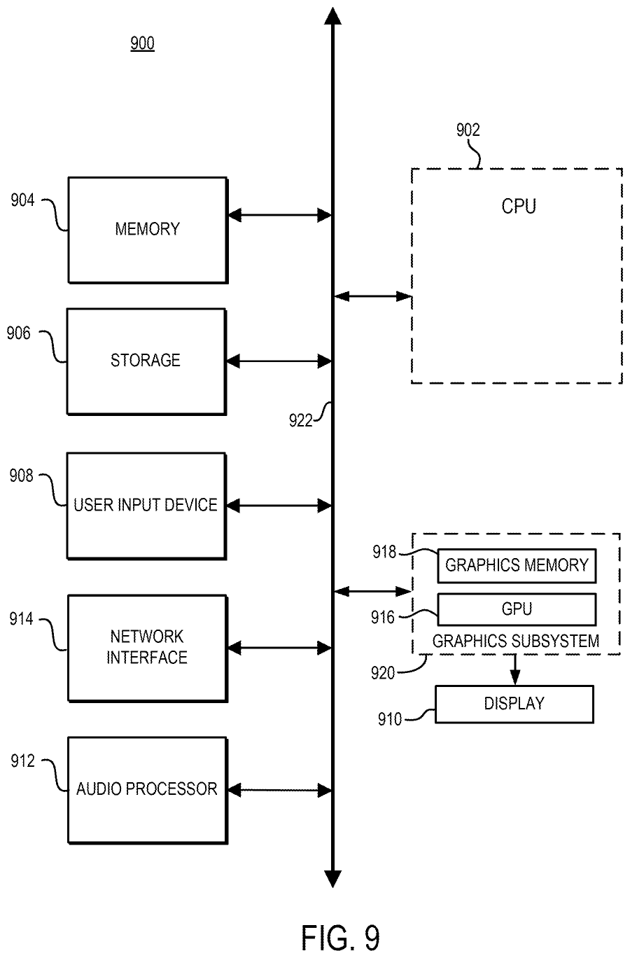

FIG. 9 illustrates components of an example device 900 that can be used to perform aspects of the various embodiments of the present disclosure. This block diagram illustrates a device 900 that can incorporate or can be a personal computer, video game console, personal digital assistant, a server or other digital device, suitable for practicing an embodiment of the disclosure. Device 900 includes a central processing unit (CPU) 902 for running software applications and optionally an operating system. CPU 902 may be comprised of one or more homogeneous or heterogeneous processing cores. For example, CPU 902 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 900 may be a localized to a player playing a game segment (e.g., game console), or remote from the player (e.g., back-end server processor), or one of many servers using virtualization in a game cloud system for remote streaming of gameplay to clients.

Memory 904 stores applications and data for use by the CPU 902. Storage 906 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 908 communicate user inputs from one or more users to device 900, examples of which may include keyboards, mice, joysticks, touch pads, touch screens, still or video recorders/cameras, tracking devices for recognizing gestures, and/or microphones. Network interface 914 allows device 900 to communicate with other computer systems via an electronic communications network, and may include wired or wireless communication over local area networks and wide area networks such as the internet. An audio processor 912 is adapted to generate analog or digital audio output from instructions and/or data provided by the CPU 902, memory 904, and/or storage 906. The components of device 900, including CPU 902, memory 904, data storage 906, user input devices 908, network interface 910, and audio processor 912 are connected via one or more data buses 922.

A graphics subsystem 920 is further connected with data bus 922 and the components of the device 900. The graphics subsystem 920 includes a graphics processing unit (GPU) 916 and graphics memory 918. Graphics memory 918 includes a display memory (e.g., a frame buffer) used for storing pixel data for each pixel of an output image. Graphics memory 918 can be integrated in the same device as GPU 908, connected as a separate device with GPU 916, and/or implemented within memory 904. Pixel data can be provided to graphics memory 918 directly from the CPU 902. Alternatively, CPU 902 provides the GPU 916 with data and/or instructions defining the desired output images, from which the GPU 916 generates the pixel data of one or more output images. The data and/or instructions defining the desired output images can be stored in memory 904 and/or graphics memory 918. In an embodiment, the GPU 916 includes 3D rendering capabilities for generating pixel data for output images from instructions and data defining the geometry, lighting, shading, texturing, motion, and/or camera parameters for a scene. The GPU 916 can further include one or more programmable execution units capable of executing shader programs.

The graphics subsystem 914 periodically outputs pixel data for an image from graphics memory 918 to be displayed on display device 910. Display device 910 can be any device capable of displaying visual information in response to a signal from the device 900, including CRT, LCD, plasma, and OLED displays. Device 900 can provide the display device 910 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet.

It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g. prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g. accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g. accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g. feedback data) from the client device or directly from the cloud gaming server.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for on-boarding users to new device features of a device, comprising:
detecting use of the device by a user during a session;
detecting an interactive scenario during use of the device, the interactive scenario including a plurality of device features usable to move along interactive pathways for the interactive scenario;
identifying a new device feature along a new interactive pathway during said use of the device, the identifying of the new device feature is based on learning of device features used by the user in one or more prior interactive scenarios; and
identifying a training scenario for the new device feature, the training scenario is accessible via an interactive interface that enables demonstration use of the new device feature;
wherein the new device feature is identified for said training scenario when the new device feature is present as an option along one or more of said interactive pathways.

2. The method of claim 1, wherein the training scenario is usable during the session of use of the device by pausing content being used via the device, such that the interactive interface enables said demonstration use of the new device feature without affecting a state of the content that is paused while in the training scenario for the new device feature.

3. The method of claim 1, wherein the training scenario is usable via the interactive interface accessible via a secondary device, the secondary device enabling said demonstration use of the new device feature.

4. The method of claim 1, wherein the interactive interface is configured to save a plurality of new device features that are added to the interactive interface during one or more sessions of use of the device, and each of said plurality of new device features is provided with a corresponding training scenario.

5. The method of claim 4, wherein the interactive interface is accessible via the device or a secondary device, the secondary device provided with access to demonstration use of selected ones of said plurality of new device features.

6. The method of claim 4, wherein the interactive interface is configured to save the plurality of new device features that are added to the interactive interface during one or more sessions of use of the device, the plurality of new device features are identified using a feature on-boarding processor, the feature on-boarding processor implements said learning via an interactive pathway model.

7. The method of claim 6, wherein the interactive pathway model is configured to generate new feature recommendations for the user based on user device interaction.

8. The method of claim 7, wherein the interactive pathway model is configured to process profile features of the user, scenario features during the device interaction, and device features for the device, the device features for the device include a plurality of new features.

9. The method of claim 1, further comprising,
generating a notification icon to notify the user that a new device feature has been identified along the new interactive pathway, said notification icon is selectable for displaying a notification message to display information associated with the new device feature.

10. The method of claim 9, wherein the new device feature is automatically added to an interactive interface when the notification icon is not selected to display the notification message.

11. The method of claim 10, wherein the notification message disappears when the notification icon is not selected to display the notification message.

12. The method of claim 1, wherein identifying the new device feature along the new interactive pathway is further based on processing features from a profile of the user, interactive scenario during user device interaction, the features being classified and used to build an interactive pathway model that identifies relationships between the new device feature and the interactive scenario.

13. A non-transitory computer-readable storage medium storing a computer program, the computer-readable storage medium comprising:
program instructions for detecting use of a device by a user during a session;
program instructions for detecting an interactive scenario during use of the device, the interactive scenario including a plurality of device features usable to move along interactive pathways for the interactive scenario;
program instructions for identifying the new device feature along a new interactive pathway during said use of the device, the identifying of the new device feature is based on learning of device features used by the user in one or more prior interactive scenarios; and
program instructions for identifying a training scenario for the new device feature, the training scenario is accessible via an interactive interface that enables demonstration use of the new device feature;
wherein the new device feature is identified for said training scenario when the new device feature is present as an option along one or more of said interactive pathways.

14. The storage medium as recited in claim 13, wherein the training scenario is usable during the session of use of the device by pausing content being used via the device, such that the interactive interface enables said demonstration use of the new device feature without affecting a state of the content that is paused while in the training scenario for the new device feature.

15. The storage medium as recited in claim 13, wherein the training scenario is usable via the interactive interface accessible via a secondary device, the secondary device enabling said demonstration use of the new device feature.

16. The storage medium as recited in claim 13, wherein the interactive interface is configured to save the plurality of new device features that are added to the interactive interface during one or more sessions of use of the device, the plurality of new device features are identified using a feature on-boarding processor, the feature on-boarding processor implements said learning via an interactive pathway model.

17. The storage medium as recited in claim 16 wherein the interactive pathway model is configured to generate new feature recommendations for the user based on user device interaction.

18. The storage medium as recited in claim 17 wherein the interactive pathway model is configured to process profile features of the user, scenario features during the device interaction, and device features for the device, the device features for the device include a plurality of new features.

19. The storage medium as recited in claim 13, further comprising, program instructions for generating a notification icon to notify the user that a new device feature has been identified along the new interactive pathway, said notification icon is selectable for displaying a notification message to display information associated with the new device feature.

20. The storage medium as recited in claim 13 wherein the identifying the new device feature along the new interactive pathway is further based on processing features from a profile of the user, interactive scenario during user device interaction, the features being classified and used to build an interactive pathway model that identifies relationships between the new device feature and the interactive scenario.
